(19) United States
(12) Patent Application Publication
(10) Pub. No.: US 2025/0080299 A1
(43) Pub. Date: Mar. 6, 2025

(54) EFFICIENT CONFIGURATION OF MULTIPLE TRANSMISSION CONFIGURATION INDICATOR STATE INDICATION MODES

(71) Applicant: QUALCOMM Incorporated, San Diego, CA (US)

(72) Inventors: Tianyang BAI, Mountain View, CA (US); Yan ZHOU, San Diego, CA (US); Fang YUAN, Beijing (CN); Tao LUO, San Diego, CA (US); Junyi LI, Fairless Hills, PA (US)

(21) Appl. No.: 18/558,884

(22) PCT Filed: Jul. 5, 2021
(86) PCT No.: PCT/CN2021/104446

§ 371 Date: Nov. 3, 2023

(51) Int. Cl. H04L 5/00; H04B 7/06

(52) U.S. Cl. CPC H04L 5/0053; H04B 7/06968; H04L 5/0094

(57) ABSTRACT

Various aspects of the present disclosure generally relate to wireless communication. In some aspects, a user equipment (UE) may receive, from a base station, a transmission configuration indicator (TCI) configuration that includes shared TCI state configuration information for multiple TCI state indication modes. The UE may receive, from the base station, an indication of a TCI state indication mode of the multiple TCI state indication modes. The UE may communicate with the base station using a beam direction associated with a TCI state in the TCI state indication mode based at least in part on the shared TCI state configuration information. Numerous other aspects are described.

### FIELD OF THE DISCLOSURE

Aspects of the present disclosure generally relate to wireless communication and to techniques and apparatuses for efficient configuration of multiple transmission configuration indicator (TCI) state indication modes.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The user equipment may include a memory and one or more processors coupled to the memory. The one or more processors may be configured to receive, from a base station, a transmission configuration indicator (TCI) configuration that includes shared TCI state configuration information for multiple TCI state indication modes. The one or more processors may be configured to receive, from the base station, an indication of a TCI state indication mode of the multiple TCI state indication modes. The one or more processors may be configured to communicate with the base station using a beam direction associated with a TCI state in the TCI state indication mode based at least in part on the shared TCI state configuration information.

Some aspects described herein relate to a base station for wireless communication. The base station may include a memory and one or more processors coupled to the memory. The one or more processors may be configured to transmit, to a UE, a TCI configuration that includes shared TCI state configuration information for multiple TCI state indication modes The one or more processors may be configured to transmit, to the UE, an indication of a TCI state indication mode of the multiple TCI state indication modes. The one or more processors may be configured to communicate with the UE using a beam direction associated with a TCI state in the TCI state indication mode based at least in part on the shared TCI state configuration information.

Some aspects described herein relate to a method of wireless communication performed by a UE. The method may include receiving, from a base station, a TCI configuration that includes shared TCI state configuration information for multiple TCI state indication modes. The method may include receiving, from the base station, an indication of a TCI state indication mode of the multiple TCI state indication modes. The method may include communicating with the base station using a beam direction associated with a TCI state in the TCI state indication mode based at least in part on the shared TCI state configuration information.

Some aspects described herein relate to a method of wireless communication performed by a base station. The method may include transmitting, to a UE, a TCI configuration that includes shared TCI state configuration information for multiple TCI state indication modes. The method may include transmitting, to the UE, an indication of a TCI state indication mode of the multiple TCI state indication modes. The method may include communicating with the UE using a beam direction associated with a TCI state in the TCI state indication mode based at least in part on the shared TCI state configuration information.

Some aspects described herein relate to a non-transitory computer-readable medium that stores a set of instructions for wireless communication by a UE. The set of instructions, when executed by one or more processors of the UE, may cause the UE to receive, from a base station, a TCI configuration that includes shared TCI state configuration information for multiple TCI state indication modes. The set of instructions, when executed by one or more processors of the UE, may cause the UE to receive, from the base station, an indication of a TCI state indication mode of the multiple TCI state indication modes. The set of instructions, when executed by one or more processors of the UE, may cause the UE to communicate with the base station using a beam direction associated with a TCI state in the TCI state indication mode based at least in part on the shared TCI state configuration information.

Some aspects described herein relate to a non-transitory computer-readable medium that stores a set of instructions for wireless communication by a base station. The set of instructions, when executed by one or more processors of the base station, may cause the base station to transmit, to a UE, a TCI configuration that includes shared TCI state configuration information for multiple TCI state indication modes. The set of instructions, when executed by one or more processors of the base station, may cause the base station to transmit, to the UE, an indication of a TCI state indication mode of the multiple TCI state indication modes. The set of instructions, when executed by one or more processors of the base station, may cause the base station to communicate with the UE using a beam direction associated with a TCI state in the TCI state indication mode based at least in part on the shared TCI state configuration information.

Some aspects described herein relate to an apparatus for wireless communication. The apparatus may include means for receiving, from a base station, a TCI configuration that includes shared TCI state configuration information for multiple TCI state indication modes. The apparatus may include means for receiving, from the base station, an indication of a TCI state indication mode of the multiple TCI state indication modes. The apparatus may include means for communicating with the base station using a beam direction associated with a TCI state in the TCI state indication mode based at least in part on the shared TCI state configuration information.

Some aspects described herein relate to an apparatus for wireless communication. The apparatus may include means for transmitting, to a UE, a TCI configuration that includes shared TCI state configuration information for multiple TCI state indication modes. The apparatus may include means for transmitting, to the UE, an indication of a TCI state indication mode of the multiple TCI state indication modes. The apparatus may include means for communicating with the UE using a beam direction associated with a TCI state in the TCI state indication mode based at least in part on the shared TCI state configuration information.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of using beams for communications between a base station and a UE, in accordance with the present disclosure.

FIG. 4 is a diagram illustrating an example associated with efficient configuration of multiple transmission configuration indicator (TCI) state indication modes, in accordance with the present disclosure.

FIGS. 5-6 are diagrams illustrating example processes associated with efficient configuration of multiple TCI state indication modes, in accordance with the present disclosure.

FIGS. 7-8 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

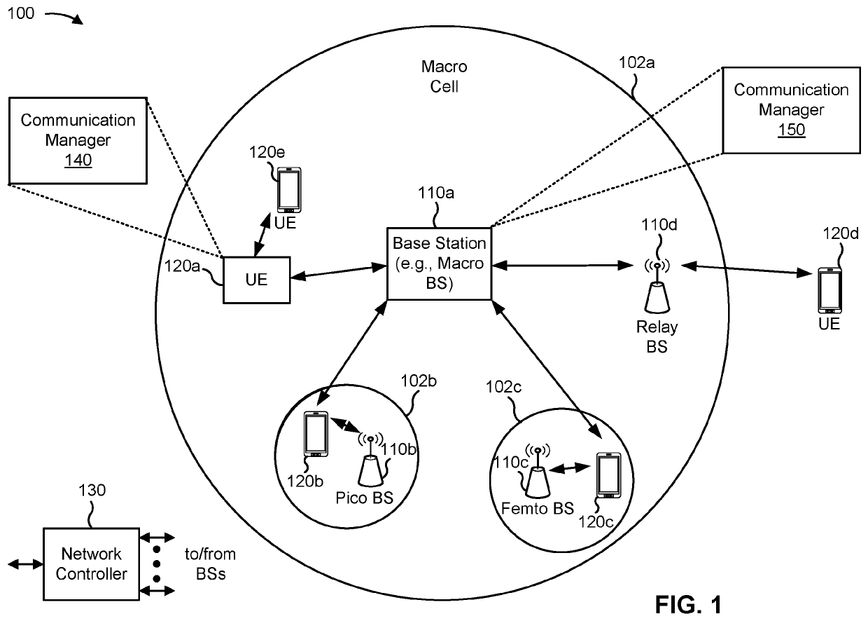

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a base station, a transmission configuration indicator (TCI) configuration that includes shared TCI state configuration information for multiple TCI state indication modes; receive, from the base station, an indication of a TCI state indication mode of the multiple TCI state indication modes; and communicate with the base station using a beam direction associated with a TCI state in the TCI state indication mode based at least in part on the shared TCI state configuration information. Additionally, or alternatively, the communication manager 140 may perform one or more other operations described herein.

In some aspects, the base station 110 may include a communication manager 150. As described in more detail elsewhere herein, the communication manager 150 may transmit, to a UE, a TCI configuration that includes shared TCI state configuration information for multiple TCI state indication modes; transmit, to the UE, an indication of a TCI state indication mode of the multiple TCI state indication modes; and communicate with the UE using a beam direction associated with a TCI state in the TCI state indication mode based at least in part on the shared TCI state configuration information. Additionally, or alternatively, the communication manager 150 may perform one or more other operations described herein.

As indicated above, FIG. 1 is provided as an example. Other examples may differ from what is described with regard to FIG. 1.

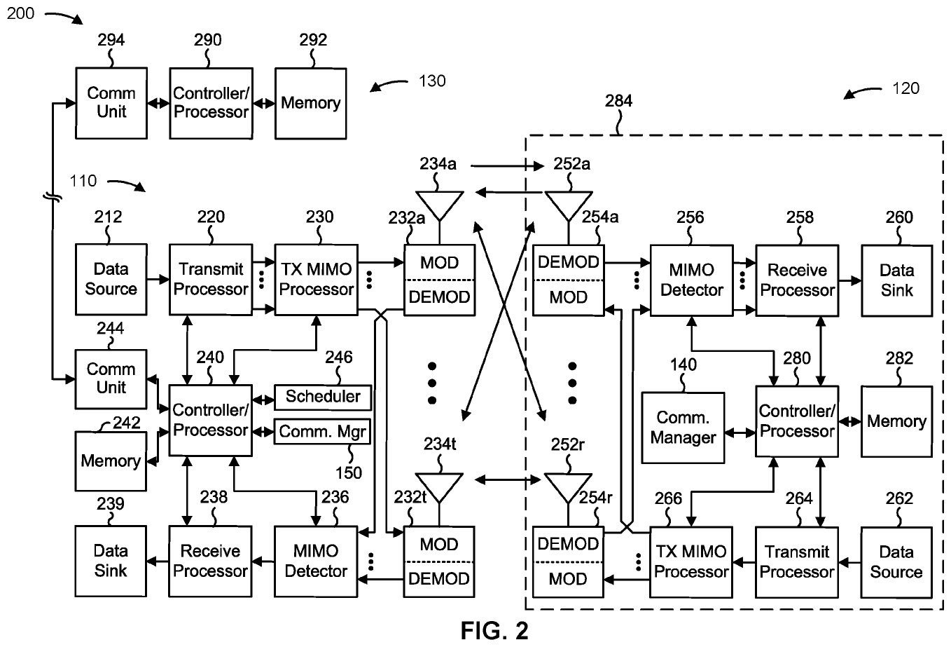

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The UE 120 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g, a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

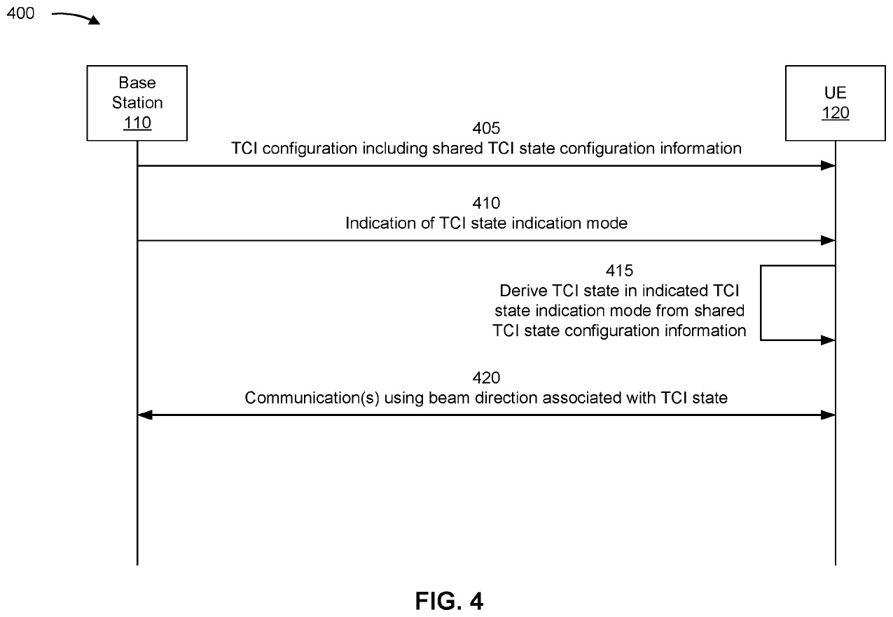

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-8).

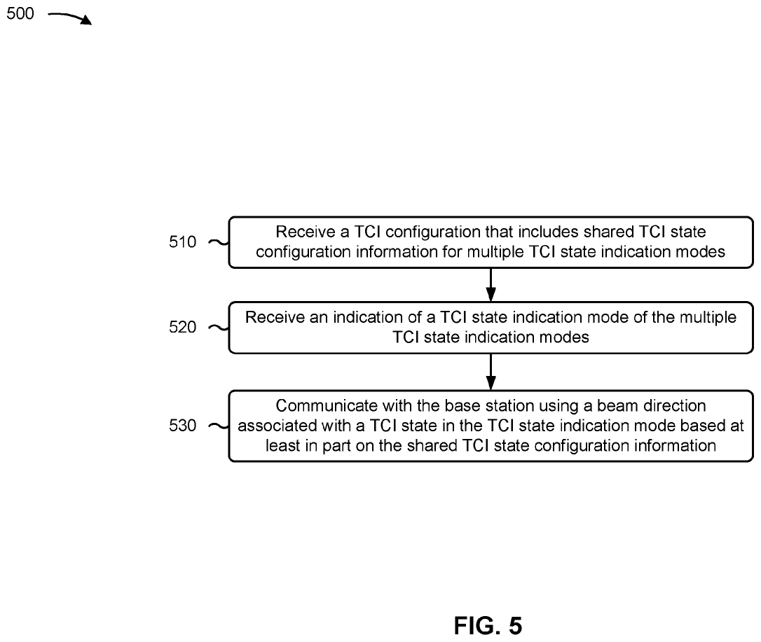

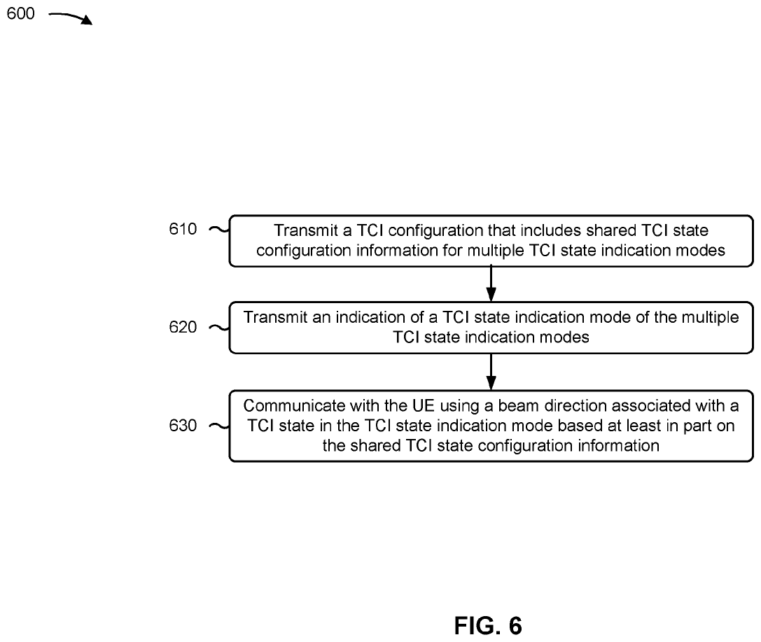

The controller/processor 240 of the base station 110, the controller/processor 280 of the UE 120, and/or any other component(s) of FIG. 2 may perform one or more techniques associated with efficient configuration of multiple TCI state indication modes, as described in more detail elsewhere herein. For example, the controller/processor 240 of the base station 110, the controller/processor 280 of the UE 120, and/or any other component(s) of FIG. 2 may perform or direct operations of, for example, process 500 of FIG. 5, process 600 of FIG. 6, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some examples, executing instructions may include running the instructions, converting the instructions, compiling the instructions, and/or interpreting the instructions, among other examples.

In some aspects, the UE 120 includes means for receiving, from a base station, a TCI configuration that includes shared TCI state configuration information for multiple TCI state indication modes; means for receiving, from the base station, an indication of a TCI state indication mode of the multiple TCI state indication modes; and/or means for communicating with the base station using a beam direction associated with a TCI state in the TCI state indication mode based at least in part on the shared TCI state configuration information. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for transmitting, to a UE, a TCI configuration that includes shared TCI state configuration information for multiple TCI state indication modes; means for transmitting, to the UE, an indication of a TCI state indication mode of the multiple TCI state indication modes; and/or means for communicating with the UE using a beam direction associated with a TCI state in the TCI state indication mode based at least in part on the shared TCI state configuration information. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

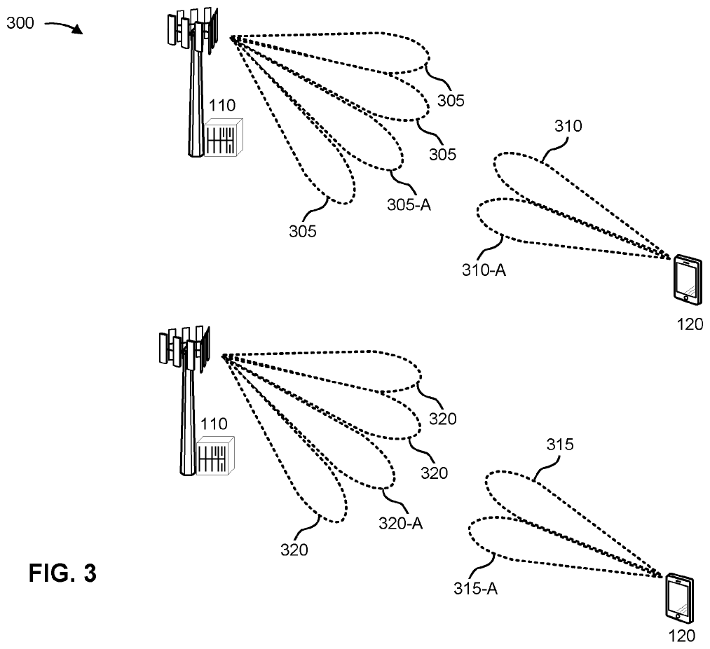

FIG. 3 is a diagram illustrating an example 300 of using beams for communications between a base station and a UE, in accordance with the present disclosure. As shown in FIG. 3, a base station 110 and a UE 120 may communicate with one another.

The base station 110 may transmit to UEs 120 located within a coverage area of the base station 110. The base station 110 and the UE 120 may be configured for beamformed communications, where the base station 110 may transmit in the direction of the UE 120 using a directional BS transmit beam, and the UE 120 may receive the transmission using a directional UE receive beam. Each BS transmit beam may have an associated beam ID, beam direction, or beam symbols, among other examples. The base station 110 may transmit downlink communications via one or more BS transmit beams 305.

The UE 120 may attempt to receive downlink transmissions via one or more UE receive beams 310, which may be configured using different beamforming parameters at receive circuitry of the UE 120. The UE 120 may identify a particular BS transmit beam 305, shown as BS transmit beam 305-A, and a particular UE receive beam 310, shown as UE receive beam 310-A, that provide relatively favorable performance (for example, that have a best channel quality of the different measured combinations of BS transmit beams 305 and UE receive beams 310). In some examples, the UE 120 may transmit an indication of which BS transmit beam 305 is identified by the UE 120 as a preferred BS transmit beam, which the base station 110 may select for transmissions to the UE 120. The UE 120 may thus attain and maintain a beam pair link (BPL) with the base station 110 for downlink communications (for example, a combination of the BS transmit beam 305-A and the UE receive beam 310-A), which may be further refined and maintained in accordance with one or more established beam refinement procedures.

A downlink beam, such as a BS transmit beam 305 or a UE receive beam 310, may be associated with a TCI state. A TCI state may indicate a directionality or a characteristic of the downlink beam, such as one or more QCL properties of the downlink beam. A QCL property may include, for example, a Doppler shift, a Doppler spread, an average delay, a delay spread, or spatial receive parameters, among other examples. In some examples, each BS transmit beam 305 may be associated with a synchronization signal block (SSB), and the UE 120 may indicate a preferred BS transmit beam 305 by transmitting uplink transmissions in resources of the SSB that are associated with the preferred BS transmit beam 305. A particular SSB may have an associated TCI state (for example, for an antenna port or for beamforming). The base station 110 may, in some examples, indicate a downlink BS transmit beam 305 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 310 at the UE 120. Thus, the UE 120 may select a corresponding UE receive beam 310 from a set of BPLs based at least in part on the base station 110 indicating a BS transmit beam 305 via a TCI indication.

The base station 110 may maintain a set of activated TCI states for downlink shared channel transmissions and a set of activated TCI states for downlink control channel transmissions. The set of activated TCI states for downlink shared channel transmissions may correspond to beams that the base station 110 uses for downlink transmission on a physical downlink shared channel (PDSCH). The set of activated TCI states for downlink control channel communications may correspond to beams that the base station 110 may use for downlink transmission on a physical downlink control channel (PDCCH) or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as a radio resource control (RRC) message.

Similarly, for uplink communications, the UE 120 may transmit in the direction of the base station 110 using a directional UE transmit beam, and the base station 110 may receive the transmission using a directional BS receive beam. Each UE transmit beam may have an associated beam ID, beam direction, or beam symbols, among other examples. The UE 120 may transmit uplink communications via one or more UE transmit beams 315.

The base station 110 may receive uplink transmissions via one or more BS receive beams 320. The base station 110 may identify a particular UE transmit beam 315, shown as UE transmit beam 315-A, and a particular BS receive beam 320, shown as BS receive beam 320-A, that provide relatively favorable performance (for example, that have a best channel quality of the different measured combinations of UE transmit beams 315 and BS receive beams 320). In some examples, the base station 110 may transmit an indication of which UE transmit beam 315 is identified by the base station 110 as a preferred UE transmit beam, which the base station 110 may select for transmissions from the UE 120. The UE 120 and the base station 110 may thus attain and maintain a BPI for uplink communications (for example, a combination of the UE transmit beam 315-A and the BS receive beam 320-A), which may be further refined and maintained in accordance with one or more established beam refinement procedures. In some examples, an uplink beam, such as a UE transmit beam 315 or a BS receive beam 320, may be associated with a spatial relation. A spatial relation may indicate a directionality or a characteristic of the uplink beam, similar to one or more QCL properties, as described above.

In some examples, instead of using a TCI state for a downlink beam indication and a spatial relation for an uplink beam indication, the base station 110 and the UE 120 may use a unified TCI state framework for downlink and uplink beams indications. In the unified TCI state framework, TCI state indications may be used to indicate a joint downlink and uplink TCI state or to indicate separate downlink and uplink TCI states. A unified TCI state indication (e.g., a joint downlink and uplink TCI state indication and/or separate downlink and uplink TCI state indications) may be applied to multiple channels. For example, the joint downlink and uplink TCI state indication may be used to indicate a beam direction for one or more downlink channels (e.g., PDSCH and/or PDCCH) and for one or more uplink channels (e.g., a physical uplink shared channel (PUSCH) and/or a physical uplink control channel (PUCCH)). The separate downlink TCI state indication may be used to indicate a beam direction for multiple downlink channels (e.g., PDSCH and PDCCH), and the separate uplink TCI state indication may be used to indicate a beam direction to be used for multiple uplink channels (e.g., PUSCH and PUCCH). In some examples, the unified TCI state indication may be “sticky,” such that the indicated beam direction will be used for the channels to which the TCI state indication applies until a further indication is received.

In some examples, there may be two TCI state indication modes in the unified TCI state framework. A first mode may be a separate downlink and uplink TCI state indication mode, in which separate downlink and uplink TCI states are used to indicate downlink and uplink beam directions for the UE 120. For example, the separate downlink and uplink TCI state indication mode may be used when the UE 120 is having maximum permissible exposure (MPE) issues to indicate different beam directions, for the UF 120, for an uplink beam (e.g., a UE transmit beam 315) and a downlink beam (e.g., a UE receive beam 310). A second mode may be a joint downlink and uplink TCI state indication mode, in which a TCI state indication is used to indicate, to the UE 120, a joint uplink and downlink beam direction. For example, the joint downlink and uplink TCI state indication mode may be used when the UE 120 has channel correspondence between downlink and uplink channels (which may be assumed in some examples) and the same beam direction can be used for an uplink beam (e.g., a UE transmit beam 315) and a downlink beam (e.g., a UE receive beam 315).

In some cases, the UE 120 may receive signaling from the base station 110 that indicates which TCI state indication mode is being used for a beam indication. In some examples, TCI states may be configured at the UE 120 for the joint downlink and uplink TCI state indication mode and for the separate downlink and uplink TCI state indication mode, and the base station 110 may use a medium access control (MAC) control element (MAC-CE) or downlink control information (DCI) signaling to select the TCI state indication mode and/or the TCI state for the UE 120 to use. For example, separate pools of TCI states may be configured for the UE 120 in RRC signaling, and the base station 110 may transmit, to the UE 120, an indication (e.g., in a MAC-CE or DCI) of a selected pool of TCI states to be active for the UE 120.

As indicated above, FIG. 3 is provided as an example. Other examples may differ from what is described with respect to FIG. 3.

As described above in connection with FIG. 3, in the unified TCI state framework, different pools of TCI states may be configured, for a UE, for different TCI state indication modes. In some cases, an RRC configuration may configure a first pool of TCI states for a joint downlink and uplink TCI state indication mode and a second pool of TCI states for a separate downlink and uplink TCI state indication mode. However, the configuration of multiple pools of TCI states corresponding to multiple TCI state indication modes may cause increased overhead in the configuration signaling (e.g., in RRC) and may also utilize significant UE cache and/or memory resources. For example, in a case in which a maximum of 128 beamforming directions can be configured for uplink and downlink, a UE may be configured with 128 configurations of TCI states for separate downlink TCI state indications, 128 configurations of TCI states for separate uplink TCI state indications, and 128 configurations of TCI states for joint downlink and uplink TCI state indications. Furthermore, TCI state configurations are not static, and the configured pools of TCI states may be reconfigured as the UE moves, resulting in significant configuration signaling overhead each time the configured pools of TCI states are reconfigured. Such configuration signaling overhead may result in reduced network speed and throughput and increased latency of network traffic.

Some techniques and apparatuses described herein enable efficient configuration of multiple TCI state indication modes. In some aspects, a UE may receive, from a base station, a TCI configuration that includes shared TCI state configuration information for multiple TCI state indication modes. The UE may receive, from the base station, an indication of a TCI state indication mode of the multiple TCI state indication modes, and the UE may communicate with the base station using a beam direction associated with a TCI state in the TCI state indication mode based at least in part on the shared TCI state configuration information. As a result, the configuration signaling overhead may be reduced, as compared with configuring separate pools of TCI states for each of the multiple TCI state indication modes. Such reduced configuration signaling overhead may result in increased network speed and throughput and decreased latency of network traffic. Furthermore, the efficient configuration of the multiple TCI state indication modes may reduce UE cache and/or memory resources used for the TCI state configurations for the multiple TCI state indication modes.

FIG. 4 is a diagram illustrating an example 400 associated with efficient configuration of multiple TCI state indication modes, in accordance with the present disclosure. As shown in FIG. 4, example 400 includes communication between a base station 110 and a UE 120. In some aspects, the base station 110 and the UE 120 may be included in a wireless network, such as wireless network 100. The base station 110 and the UE 120 may communicate via a wireless access link, which may include an uplink and a downlink.

As shown in FIG. 4, and by reference number 405, the base station 110 may transmit, to the UE 120, a TCI configuration that includes shared TCI state configuration information for multiple TCI state indication modes. The UE 120 may receive the TCI configuration transmitted by the base station 110. For example, the base station 110 may transmit the TCI configuration to the UE 120 in an RRC message. The TCI configuration may configure multiple TCI state indication modes for the UE 120. For example, the multiple TCI state indication modes may include a joint downlink and uplink TCI state indication mode and a separate downlink and uplink TCI state indication mode. The shared TCI state configuration information may be shared by the multiple TCI state indication modes.

In some aspects, the shared TCI state configuration information may include a set of configured TCI states that may be used to derive beam directions associated with TCI state indications in the multiple TCI state indication modes. In some aspects, the shared TCI state configuration information may also include mappings between the set of configured TCI states in the shared TCI state configuration information and TCI states in the multiple TCI state indication modes. For example, the shared TCI state information may identify, for each TCI state indication mode, a respective mapping or linkage between the set of configurated TCI states in the shared TCI state configuration information and TCI state indications in that TCI state indication mode. Based at least in part on the respective mapping for each TCI state indication mode, the UE 120 may be able to derive a respective TCI state pool for each TCI state indication mode from the set of TCI state configurations in the shared TCI state configuration information (e.g., from a shared pool of TCI state configurations). In some aspects, the TCI state configuration information may include a mapping between the set of configured TCI states in the shared TCI configuration information and TCI states for joint downlink and uplink TCI state indication, a mapping between the set of configured TCI states in the shared TCI state configuration information and TCI states for separate downlink TCI state indication, and a mapping between the set of configured TCI states in the shared TCI state configuration information and TCI states for separate uplink TCI state indication.

In some aspects, the set of configured TCI states in the shared TCI state configuration information may be a set of configured TCI states for the joint downlink and uplink TCI state indication mode (e.g., there may be a one-to-one mapping between the set of configured TCI states in the shared TCI state configuration and the TCI state pool for the joint downlink and uplink TCI state indication mode). In this case, the shared TCI state configuration information may include a mapping between the configured TCI states for the joint downlink and uplink TCI state indication mode and TCI states for the separate downlink and uplink TCI state configuration mode (e.g., a mapping or linkage between the TCI state pool for the joint downlink and uplink TCI state indication mode and a TCI state pool for the separate downlink and uplink TCI state indication mode). For example, the shared TCI state configuration information may include a mapping between the configured TCI states for the joint downlink and uplink TCI state indication mode and TCI states for separate downlink TCI state indication and a mapping between the configured TCI states for the joint downlink and uplink TCI state indication mode and TCI states for separate uplink TCI state indication.

In some aspects, the shared TCI state configuration information may include, for each configured TCI state in a set of configured TCI states, an indication of one or more QCL types for the configured TCI state. The shared TCI state configuration information may also include an indication of a respective source RS for each of the one or more QCL types for a configured TCI state. Each QCL type may be associated with one or more parameters (e.g., QCL properties) that are set for the configured TCI state to be the same as those parameters in the respective source RS. For example, the QCL types for a configured TCI state in the shared TCI state configuration information may include one or more of QCL type A (e.g., Doppler shift, Doppler spread, average delay, and delay spread), QCL type B (e.g., Doppler shift and Doppler spread), QCL type C (e.g., Doppler shift and average delay), and/or QCL type D (e.g., spatial receive parameter).

In some aspects, the shared TCI state configuration information may include a bandwidth part and/or component carrier identifier (CC ID) information associated with each configured TCI state of the set of configured TCI states identified in the shared TCI state configuration information. In some aspects, the shared TCI state configuration may include an indication of power control parameters and a path loss reference signal for each configured TCI state of the set of configured TCI states identified in the shared TCI state configuration information. For example, the power control parameters may include a fractional power control parameter (a), a minimum receive power needed at the base station 110 (Po), and a closed loop index, among other examples.

In some aspects, the power control parameters may not be included in the shared TCI state configuration information. In some aspects, in a case in which the power control parameters are not included in the shared TCI state configuration information, one or more sets of power control parameters may be configured for the UE 120 in configuration information other than the shared TCI state configuration information. For example, configuration information that identifies one or more configured sets of power control parameters may be included in the TCI configuration or transmitted by the base station 110 in another configuration (e.g., RRC message). In this case, a respective index value may be associated with each configured set of power control parameters.

As further shown in FIG. 4, and by reference number 410, the base station 110 may transmit, to the UE 120, an indication of a TCI state indication mode of the multiple TCI state indication modes configured for the UE 120. The UE 120 may receive, from the base station 110, the indication of the TCI state indication mode. For example, the base station 110 may transmit the indication of the TCI state indication mode to the UE 120 in a MAC-CE or DCI. The indication may indicate which TCI state indication mode is to be applied by the UE 120. For example, the indication may indicate the joint downlink and uplink TCI state indication mode, a separate downlink TCI state indication mode, and/or a separate uplink TCI state indication mode.

In some aspects, only one TCI state indication mode (e.g., one TCI state pool) may be active at a time for the UE 120. In this case, the indication may indicate an activated TCI state indication mode of the multiple TCI state indication modes configured for the UE 120. For example, the indication may activate of a different TCI state indication mode from a previous activated TCI state indication mode for the UE 120.

In some aspects, two or more TCI state indication modes (e.g., two or more TCI state pools) may be activated at a time. In this case, the indication may include a dynamic indication of TCI state for a channel and a TCI state indication mode, of the multiple TCI state indication modes, for the indicated TCI state for the channel. For example, the dynamic indication of the TCI state may be included in DCI transmitted by the base station 110. In this case, the DCI may also include the indication of the TCI state indication mode. For example, the DCI may include a field for indication of the TCI state indication mode for the dynamically indicated TCI state.

In some aspects, the indication may include other parameters associated with the TCI state indication mode. In some aspects, such as in a case in which the indicated TCI state indication mode is the separate uplink TCI state indication mode or the joint downlink and uplink TCI state indication mode, and the power control parameters are not included in the shared TCI state configuration information, the indication may identify power control parameters for an uplink transmission using a beam direction associated with a TCI state in the indicated TCI state indication mode. For example, the indication can indicate values for one or more power control parameters, such as a, Po, and/or the closed loop index. In some aspects, the indication may indicate an index associated with a configured set of power control parameters.

In some aspects, the indication may indicate one or more channels to which a TCI state indication in the indicated TCI state indication mode will apply. For example, different TCI state indication modes may apply to different channels. In some aspects, the indication may indicate one or more RSs for TCI states in the TCI state indication mode. For example, the indication may indicate source RSs for the UE 120 to use for TCI state indications in the indicated TCI state indication mode.

As further shown in FIG. 4, and by reference number 415, UE 120 may derive a TCI state in the indicated TCI state indication mode from the shared TCI stated configuration information. The UE 120 may derive a TCI state in the indicated TCI state indication mode, and a beam direction associated with that TCI state, from the shared TCI state configuration information based at least in part on the mapping between the set of configured TCI states in the shared TCI state configuration information and TCI states for the indicated TCI state indication mode. For example, a configured TCI state of the set of configured TCI states in the shared TCI state configuration information may correspond to a different TCI state in a TCI state pool for the indicated TCI state indication mode.

In some aspects, one or more fields in the shared TCI state configuration information may not be applicable to the indicated TCI state indication mode. For example, in a case in which the shared TCI state configuration information includes the power control parameters, the UE 120 may derive a separate downlink TCI state from the shared TCI state configuration information. In this case, the UE 120 may ignore the power control parameters included in the shared TCI state configuration information. For example, the UE 120 may receive, from the base station 110, a downlink communication using a beam direction associated with the derived separate downlink TCI state without applying the power control parameters associated with the configured TCI state in the shared TCI state configuration information from which the separate downlink TCI state is derived.

In some aspects, the shared TCI state configuration information may include one or more configured TCI states that are defined (for a QCL type) based on an uplink RS (e.g., a sounding reference signal (SRS)). In this case, the UE 120 may derive a separate downlink TCI state from the shared TCI state configuration information. In some aspects, the UE 120 may selectively use an uplink RS identified in the shared TCI state configuration information or use a downlink reference signal as a source RS for determining the beam direction associated with the TCI state in the separate downlink TCI state indication mode based at least in part on a capability of the UE 120. For example, the UE 120 may transmit, to the base station 110, a UE capability report that indicates whether the UE 120 supports using an uplink RS as a source RS for a downlink TCI state. In a case in which the UE 120 supports using an uplink RS as a source RS for a downlink TCI, the UF 120 may use the uplink reference signal identified in the shared TCI state configuration information as the source RS for defining the separate downlink TCI state. In a case in which the UE 120 does not support using an uplink RS as a source RS for a downlink TCI, the UE 120 may use a downlink reference signal for defining the separate downlink TCI state, instead of using the uplink RS identified in the shared TCI state configuration information. In some aspects, the UE 120 may use a predefined downlink RS or predefined type of downlink RS, instead of the uplink RS identified in the shared TCI state configuration information, as a source RS for defining the separate downlink TCI state. In some aspects, the UE 120 may use, as the source RS for defining the downlink TCI state, a downlink reference signal (e.g., an SSB) which is used to define the source uplink reference signal identified in the shared TCI state configuration information. In some aspects, the UE 120 may receive, from the base station 110, a dynamic indication that identifies a downlink RS to use for the source RS, and the UE 120 may use the downlink RS identified in the indication received from the base station 110 as the source RS for defining the separate downlink TCI state.

As further shown in FIG. 4, and by reference number 420, the UE 120 and the base station 110 may communicate using the beam direction associated with the TCI state determined based at least in part on the shared TCI state configuration information.

In some aspects, the UE 120 may derive a joint downlink and uplink TCI state (e.g., a TCI state in the joint downlink and uplink TCI state indication mode) and the beam direction associated with that TCI state based at least in part on the shared TCI state configuration information. In this case, the UE 120 may receive one or more downlink channel communications (e.g., PDSCH and/or PDCCH) transmitted by the base station 110 and/or the UE 120 may transmit one or more uplink channel communications (e.g., PUSCH and/or PUCCH) to the base station 110 using the beam direction associated with the derived joint downlink and uplink TCI state.

In some aspects, the UE 120 may derive a separate downlink TCI state (e.g., a TCI state in the separate downlink TCI state indication mode) and the beam direction associated with that TCI state based at least in part on the shared TCI state configuration information. In this case, the UE 120 may receive one or more downlink channel communications (e.g, PDSCH and/or PDCCH) transmitted by the base station 110 using the beam direction associated with the derived separate downlink TCI state.

In some aspects, the UE 120 may derive a separate uplink TCI state (e.g., a TCI state in the separate uplink TCI state indication mode) and the beam direction associated with that TCI state based at least in part on the shared TCI state configuration information. In this case, the UE 120 may transmit one or more uplink channel communications (e.g., PUSCH and/or PUCCH) to the base station 110 using the beam direction associated with the derived separate uplink TCI state.

As described above, the UE 120 may receive, from the base station 110, a TCI configuration that includes shared TCI state configuration information for multiple TCI state indication modes. The UE 120 may receive, from the base station 110, an indication of a TCI state indication mode of the multiple TCI state indication modes, and the UE 120 may communicate with the base station 110 using a beam direction associated with a TCI state in the TCI state indication mode based at least in part on the shared TCI state configuration information. As a result, the configuration signaling overhead may be reduced, as compared with configuring separate pools of TCI states for each of the multiple TCI state indication modes. Such reduced configuration signaling overhead may result in increased network speed and throughput and decreased latency of network traffic. Furthermore, the efficient configuration of the multiple TCI state indication modes may reduce UE cache and/or memory resources used for the TCI state configurations for the multiple TCI state indication modes.

As indicated above, FIG. 4 is provided as an example. Other examples may differ from what is described with respect to FIG. 4.

FIG. 5 is a diagram illustrating an example process 500 performed, for example, by a UE, in accordance with the present disclosure. Example process 500 is an example where the UE (e.g., UE 120) performs operations associated with efficient configuration of multiple TCI state indication modes.

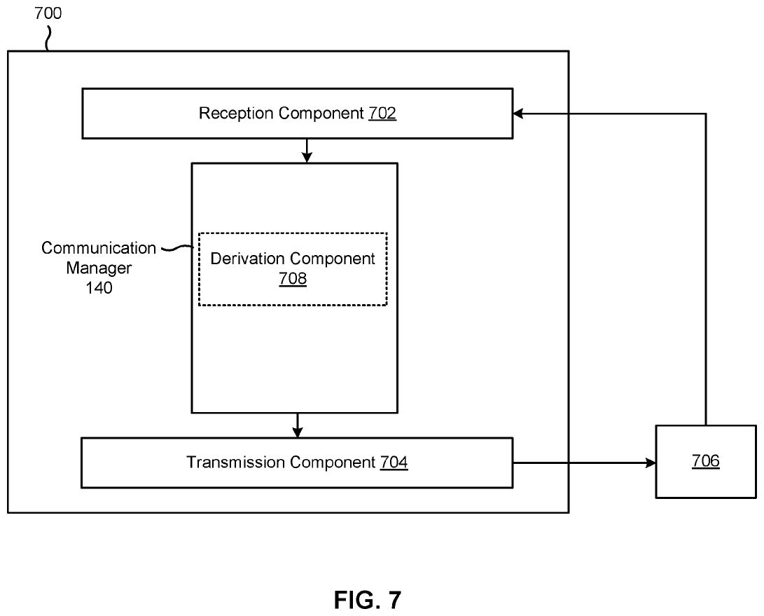

As shown in FIG. 5, in some aspects, process 500 may include receiving, from a base station, a TCI configuration that includes shared TCI state configuration information for multiple TCI state indication modes (block 510). For example, the UE (e.g., using communication manager 140 and/or reception component 702, depicted in FIG. 7) may receive, from a base station, a TCI configuration that includes shared TCI state configuration information for multiple TCI state indication modes, as described above.

As further shown in FIG. 5, in some aspects, process 500 may include receiving, from the base station, an indication of a TCI state indication mode of the multiple TCI state indication modes (block 520). For example, the UE (e.g., using communication manager 140 and/or reception component 702, depicted in FIG. 7) may receive, from the base station, an indication of a TCI state indication mode of the multiple TCI state indication modes, as described above.

As further shown in FIG. 5, in some aspects, process 500 may include communicating with the base station using a beam direction associated with a TCI state in the TCI state indication mode based at least in part on the shared TCI state configuration information (block 530). For example, the UE (e.g., using communication manager 140, reception component 702, and/or transmission component 704, depicted in FIG. 7) may communicate with the base station using a beam direction associated with a TCI state in the TCI state indication mode based at least in part on the shared TCI state configuration information, as described above.

Process 500 may include additional aspects, such as any single aspect or any combination of aspects described below and/or in connection with one or more other processes described elsewhere herein.

In a first aspect, the multiple TCI state indication modes include a joint downlink and uplink TCI state indication mode and a separate downlink and uplink TCI state indication mode.

In a second aspect, alone or in combination with the first aspect, the shared TCI state configuration information includes a set of configured TCI states, and the TCI configuration further includes mappings between the configured TCI states in the shared TCI state configuration information and TCI states in the multiple TCI state indication modes.

In a third aspect, alone or in combination with one or more of the first and second aspects, the mappings include a mapping between the configured TCI states in the shared TCI state configuration information and TCI states for joint downlink and uplink TCI state indication, a mapping between the configured TCI states in the shared TCI state configuration information and TCI states for separate downlink TCI state indication, and a mapping between the configured TCI states in the shared TCI state configuration information and TCI states for separate uplink TCI state indication.

In a fourth aspect, alone or in combination with one or more of the first through third aspects, the shared TCI state configuration information includes a set of configured TCI states for the joint downlink and uplink TCI state indication mode, and the TCI configuration further includes a mapping between the configured TCI states for the joint downlink and uplink TCI state indication mode and TCI states for the separate downlink and uplink TCI state indication mode.

In a fifth aspect, alone or in combination with one or more of the first through fourth aspects, the shared TCI state configuration information includes, for each configured TCI state in a set of configured TCI states identified in the shared TCI state configuration information, an indication of one or more QCL types for the configured TCI state and an indication of a respective source reference signal for the configured TCI state for each of the one or more QCL types.

In a sixth aspect, alone or in combination with one or more of the first through fifth aspects, the shared TCI state configuration information further includes, for each configured TCI state in the set of configured TCI states identified in the shared TCI state configuration information, at least one of bandwidth part or component carrier identifier information associated with the configured TCI state.

In a seventh aspect, alone or in combination with one or more of the first through sixth aspects, the shared TCI state configuration information further includes, for each configured TCI state in a set of configured TCI states identified in the shared TCI state configuration information, an indication of power control parameters and a path loss reference signal associated with the configured TCI state.

In an eighth aspect, alone or in combination with one or more of the first through seventh aspects, indication of a TCI state indication mode is an indication of a separate downlink TCI state indication mode, and communicating with the base station using a beam direction associated with a TCI state in the TCI state indication mode includes deriving a TCI state for the separate downlink TCI state indication mode from a configured TCI state in the set of configured TCI states identified in the shared TCI state configuration information, and receiving, from the base station, a downlink communication using a beam direction associated with the TCI state for the separate downlink TCI state indication mode, without applying the power control parameters associated with the configured TCI state from which the TCI state for the separate downlink TCI state indication mode is derived.

In a ninth aspect, alone or in combination with one or more of the first through eighth aspects, the indication is included in at least one of a MAC-CE or DCI.

In a tenth aspect, alone or in combination with one or more of the first through ninth aspects, the indication indicates an activated TCI state indication mode of the multiple TCI state indication modes.

In an eleventh aspect, alone or in combination with one or more of the first through tenth aspects, the indication includes a dynamic indication of a TCI state for a channel and a TCI state indication mode, of the multiple TCI state indication modes, for the TCI state for the channel.

In a twelfth aspect, alone or in combination with one or more of the first through eleventh aspects, the indication is an indication of a separate uplink TCI state indication mode or a joint downlink and uplink TCI state indication mode, and the indication identifies power control parameters for an uplink transmission using the beam direction associated with the TCI state in the TCI state indication mode.

In a thirteenth aspect, alone or in combination with one or more of the first through twelfth aspects, the indication indicates an index associated with a configured set of power control parameters.

In a fourteenth aspect, alone or in combination with one or more of the first through thirteenth aspects, the indication indicates at least one of one or more channels associated with the TCI state in the TCI state indication mode, or one or more reference signals associated with the TCI state in the TCI state indication mode.

In a fifteenth aspect, alone or in combination with one or more of the first through fourteenth aspects, the shared TCI state configuration information identifies configured TCI states and respective uplink reference signals associated with the configured TCI states, wherein the indication is an indication of a separate downlink TCI state indication mode, and wherein communicating with the base station using a beam direction associated with a TCI state in the TCI state indication mode includes selectively using the respective uplink reference signal associated with one of the configured TCI states or a downlink reference signal as a source reference signal for determining the beam direction associated with the TCI state in the separate downlink TCI state indication mode based at least in part on a capability of the UE.

In a sixteenth aspect, alone or in combination with one or more of the first through fifteenth aspects, selectively using the respective uplink reference signal associated with one of the configured TCI states or a downlink reference signal as a source reference signal for determining the beam direction associated with the TCI state in the separate downlink TCI state indication mode includes using the downlink reference signal as the source reference signal for determining the beam direction associated with the TCI state in the separate downlink TCI state indication mode, wherein the downlink reference signal is a reference signal used to define the respective uplink reference signal associated with the one of the configured TCI states.

In a seventeenth aspect, alone or in combination with one or more of the first through sixteenth aspects, selectively using the respective uplink reference signal associated with one of the configured TCI states or a downlink reference signal as a source reference signal for determining the beam direction associated with the TCI state in the separate downlink TCI state indication mode includes using the downlink reference signal as the source reference signal for determining the beam direction associated with the TCI state in the separate downlink TCI state indication mode, wherein the downlink reference signal is identified in an indication received from the base station.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a base station, in accordance with the present disclosure. Example process 600 is an example where the base station (e.g., base station 110) performs operations associated with efficient configuration of multiple TCI state indication modes.

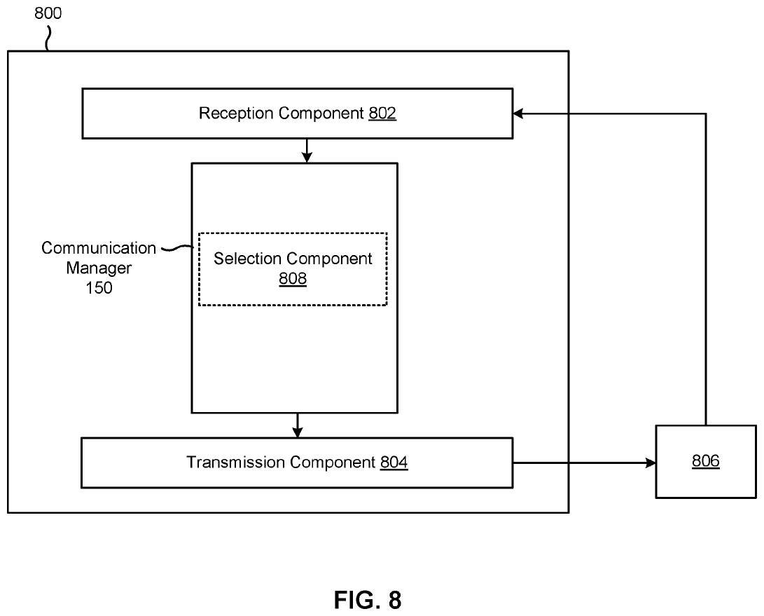

As shown in FIG. 6, in some aspects, process 600 may include transmitting, to a UE, a TCI configuration that includes shared TCI state configuration information for multiple TCI state indication modes (block 610). For example, the base station (e.g., using communication manager 150 and/or transmission component 804, depicted in FIG. 8) may transmit, to a UE, a TCI configuration that includes shared TCI state configuration information for multiple TCI state indication modes, as described above.

As further shown in FIG. 6, in some aspects, process 600 may include transmitting, to the UE, an indication of a TCI state indication mode of the multiple TCI state indication modes (block 620). For example, the base station (e.g., using communication manager 150 and/or transmission component 804, depicted in FIG. 8) may transmit, to the UE, an indication of a TCI state indication mode of the multiple TCI state indication modes, as described above.

As further shown in FIG. 6, in some aspects, process 600 may include communicating with the UE using a beam direction associated with a TCI state in the TCI state indication mode based at least in part on the shared TCI state configuration information (block 630) For example, the base station (e.g., using communication manager 150, reception component 802, and/or transmission component 804, depicted in FIG. 8) may communicate with the UE using a beam direction associated with a TCI state in the TCI state indication mode based at least in part on the shared TCI state configuration information, as described above.

Process 600 may include additional aspects, such as any single aspect or any combination of aspects described below and/or in connection with one or more other processes described elsewhere herein.

In a first aspect, the multiple TCI state indication modes include a joint downlink and uplink TCI state indication mode and a separate downlink and uplink TCI state indication mode.

In a second aspect, alone or in combination with the first aspect, the shared TCI state configuration information includes a set of configured TCI states, and the TCI configuration further includes mappings between the configured TCI states in the shared TCI state configuration information and TCI states in the multiple TCI state indication modes.

In a third aspect, alone or in combination with one or more of the first and second aspects, the mappings include a mapping between the configured TCI states in the shared TCI state configuration information and TCI states for joint downlink and uplink TCI state indication, a mapping between the configured TCI states in the shared TCI state configuration information and TCI states for separate downlink TCI state indication, and a mapping between the configured TCI states in the shared TCI state configuration information and TCI states for separate uplink TCI state indication.

In a fourth aspect, alone or in combination with one or more of the first through third aspects, the shared TCI state configuration information includes a set of configured TCI states for the joint downlink and uplink TCI state indication mode, and the TCI configuration further includes a mapping between the configured TCI states for the joint downlink and uplink TCI state indication mode and TCI states for the separate downlink and uplink TCI state indication mode.

In a fifth aspect, alone or in combination with one or more of the first through fourth aspects, the shared TCI state configuration information includes, for each configured TCI state in a set of configured TCI states identified in the shared TCI state configuration information, an indication of one or more QCL types for the configured TCI state and an indication of a respective source reference signal for the configured TCI state for each of the one or more QCL types.

In a sixth aspect, alone or in combination with one or more of the first through fifth aspects, the shared TCI state configuration information further includes, for each configured TCI state in the set of configured TCI states identified in the shared TCI state configuration information, at least one of bandwidth part or component carrier identifier information associated with the configured TCI state.

In a seventh aspect, alone or in combination with one or more of the first through sixth aspects, the shared TCI state configuration information further includes, for each configured TCI state in a set of configured TCI states identified in the shared TCI state configuration information, an indication of power control parameters and a path loss reference signal associated with the configured TCI state.

In an eighth aspect, alone or in combination with one or more of the first through seventh aspects, the indication is included in at least one of a MAC-CE or DCI.

In a ninth aspect, alone or in combination with one or more of the first through eighth aspects, the indication indicates an activated TCI state indication mode of the multiple TCI state indication modes.

In a tenth aspect, alone or in combination with one or more of the first through ninth aspects, the indication includes a dynamic indication of a TCI state for a channel and a TCI state indication mode, of the multiple TCI state indication modes, for the TCI state for the channel.

In an eleventh aspect, alone or in combination with one or more of the first through tenth aspects, the indication is an indication of a separate uplink TCI state indication mode or a joint downlink and uplink TCI state indication mode, and the indication identifies power control parameters for an uplink transmission using the beam direction associated with the TCI state in the TCI state indication mode.

In a twelfth aspect, alone or in combination with one or more of the first through eleventh aspects, the indication indicates an index associated with a configured set of power control parameters.

In a thirteenth aspect, alone or in combination with one or more of the first through twelfth aspects, the indication indicates at least one of one or more channels associated with the TCI state in the TCI state indication mode, or one or more reference signals associated with the TCI state in the TCI state indication mode.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 140. The communication manager 140 may include a derivation component 708, among other examples.

In some aspects, the apparatus 700 may be configured to perform one or more operations described herein in connection with FIG. 4. Additionally, or alternatively, the apparatus 700 may be configured to perform one or more processes described herein, such as process 500 of FIG. 5, or a combination thereof. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 706. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 706 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The reception component 702 may receive, from a base station, a TCI configuration that includes shared TCI state configuration information for multiple TCI state indication modes. The reception component 702 may receive, from the base station, an indication of a TCI state indication mode of the multiple TCI state indication modes. The reception component 702 and/or the transmission component 704 may communicate with the base station using a beam direction associated with a TCI state in the TCI state indication mode based at least in part on the shared TCI state configuration information.

The derivation component 708 may derive the TCI state in the TCI state indication mode and the beam direction associated with the TCI state in the TCI state indication mode based at least in part on the shared TCI state configuration information.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a base station, or a base station may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 150. The communication manager 150 may include a selection component 808, among other examples.

In some aspects, the apparatus 800 may be configured to perform one or more operations described herein in connection with FIG. 4. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the base station described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 806. In some aspects, the reception component 802 may include one or more antennas, a modem, a demodulator, a MIMO detector, a receive processor, a controller/processor, a memory, or a combination thereof, of the base station described in connection with FIG. 2.

The transmission component 804 may transmit communications, such as reference signals, control information, data communications, or a combination thereof, to the apparatus 806. In some aspects, one or more other components of the apparatus 806 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the base station described in connection with FIG. 2. In some aspects, the transmission component 804 may be co-located with the reception component 802 in a transceiver.

The transmission component 804 may transmit, to a UE, a TCI configuration that includes shared TCI state configuration information for multiple TCI state indication modes. The transmission component 804 may transmit, to the UE, an indication of a TCI state indication mode of the multiple TCI state indication modes. The reception component 802 and/or the transmission component 804 may communicate with the UE using a beam direction associated with a TCI state in the TCI state indication mode based at least in part on the shared TCI state configuration information.

The selection component 808 may select the TCI state indication mode indicated in the indication.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: receiving, from a base station, a transmission configuration indicator (TCI) configuration that includes shared TCI state configuration information for multiple TCI state indication modes; receiving, from the base station, an indication of a TCI state indication mode of the multiple TCI state indication modes; and communicating with the base station using a beam direction associated with a TCI state in the TCI state indication mode based at least in part on the shared TCI state configuration information.

Aspect 2: The method of Aspect 1, wherein the multiple TCI state indication modes include a joint downlink and uplink TCI state indication mode and a separate downlink and uplink TCI state indication mode.

Aspect 3: The method of Aspect 2, wherein the shared TCI state configuration information includes a set of configured TCI states, and the TCI configuration further includes mappings between the configured TCI states in the shared TCI state configuration information and TCI states in the multiple TCI state indication modes.

Aspect 4: The method of Aspect 3, wherein the mappings include a mapping between the configured TCI states in the shared TCI state configuration information and TCI states for joint downlink and uplink TCI state indication, a mapping between the configured TCI states in the shared TCI state configuration information and TCI states for separate downlink TCI state indication, and a mapping between the configured TCI states in the shared TCI state configuration information and TCI states for separate uplink TCI state indication.

Aspect 5: The method of any of Aspects 2-4, wherein the shared TCI state configuration information includes a set of configured TCI states for the joint downlink and uplink TCI state indication mode, and the TCI configuration further includes a mapping between the configured TCI states for the joint downlink and uplink TCI state indication mode and TCI states for the separate downlink and uplink TCI state indication mode.

Aspect 6: The method of any of Aspects 1-5, wherein the shared TCI state configuration information includes, for each configured TCI state in a set of configured TCI states identified in the shared TCI state configuration information, an indication of one or more quasi co-location (QCL) types for the configured TCI state and an indication of a respective source reference signal for the configured TCI state for each of the one or more QCL types.

Aspect 7: The method of Aspect 6, wherein the shared TCI state configuration information further includes, for each configured TCI state in the set of configured TCI states identified in the shared TCI state configuration information, at least one of bandwidth part or component carrier identifier information associated with the configured TCI state.

Aspect 8: The method of any of Aspects 6-7, wherein the shared TCI state configuration information further includes, for each configured TCI state in a set of configured TCI states identified in the shared TCI state configuration information, an indication of power control parameters and a path loss reference signal associated with the configured TCI state.

Aspect 9: The method of Aspect 8, wherein indication of a TCI state indication mode is an indication of a separate downlink TCI state indication mode, and communicating with the base station using a beam direction associated with a TCI state in the TCI state indication mode comprises: deriving a TCI state for the separate downlink TCI state indication mode from a configured TCI state in the set of configured TCI states identified in the shared TCI state configuration information; and receiving, from the base station, a downlink communication using a beam direction associated with the TCI state for the separate downlink TCI state indication mode, without applying the power control parameters associated with the configured TCI state from which the TCI state for the separate downlink TCI state indication mode is derived.

Aspect 10: The method of any of Aspects 1-9, wherein the indication is included in at least one of a medium access control (MAC) control element or downlink control information.

Aspect 11: The method of any of Aspects 1-10, wherein the indication indicates an activated TCI state indication mode of the multiple TCI state indication modes.

Aspect 12: The method of any of Aspects 1-11, wherein the indication includes a dynamic indication of a TCI state for a channel and a TCI state indication mode, of the multiple TCI state indication modes, for the TCI state for the channel.

Aspect 13: The method of any of Aspects 1-12, wherein the indication is an indication of a separate uplink TCI state indication mode or a joint downlink and uplink TCI state indication mode, and the indication identifies power control parameters for an uplink transmission using the beam direction associated with the TCI state in the TCI state indication mode.

Aspect 14: The method of Aspect 13, wherein the indication indicates an index associated with a configured set of power control parameters.

Aspect 15: The method of any of Aspects 1-14, wherein the indication indicates at least one of: one or more channels associated with the TCI state in the TCI state indication mode, or one or more reference signals associated with the TCI state in the TCI state indication mode.

Aspect 16: The method of any of Aspects 1-12 or 15, wherein the shared TCI state configuration information identifies configured TCI states and respective uplink reference signals associated with the configured TCI states, wherein the indication is an indication of a separate downlink TCI state indication mode, and wherein communicating with the base station using a beam direction associated with a TCI state in the TCI state indication mode comprises: selectively using the respective uplink reference signal associated with one of the configured TCI states or a downlink reference signal as a source reference signal for determining the beam direction associated with the TCI state in the separate downlink TCI state indication mode based at least in part on a capability of the UE.

Aspect 17: The method of Aspect 16, wherein selectively using the respective uplink reference signal associated with one of the configured TCI states or a downlink reference signal as a source reference signal for determining the beam direction associated with the TCI state in the separate downlink TCI state indication mode comprises: using the downlink reference signal as the source reference signal for determining the beam direction associated with the TCI state in the separate downlink TCI state indication mode, wherein the downlink reference signal is a reference signal used to define the respective uplink reference signal associated with the one of the configured TCI states.

Aspect 18: The method of Aspect 16, wherein selectively using the respective uplink reference signal associated with one of the configured TCI states or a downlink reference signal as a source reference signal for determining the beam direction associated with the TCI state in the separate downlink TCI state indication mode comprises: using the downlink reference signal as the source reference signal for determining the beam direction associated with the TCI state in the separate downlink TCI state indication mode, wherein the downlink reference signal is identified in an indication received from the base station.

Aspect 19: A method of wireless communication performed by a base station, comprising: transmitting, to a user equipment (UE), a transmission configuration indicator (TCI) configuration that includes shared TCI state configuration information for multiple TCI state indication modes; transmitting, to the UE, an indication of a TCI state indication mode of the multiple TCI state indication modes; and communicating with the UE using a beam direction associated with a TCI state in the TCI state indication mode based at least in part on the shared TCI state configuration information.

Aspect 20: The method of Aspect 19, wherein the multiple TCI state indication modes include a joint downlink and uplink TCI state indication mode and a separate downlink and uplink TCI state indication mode.

Aspect 21: The method of Aspect 20, wherein the shared TCI state configuration information includes a set of configured TCI states, and the TCI configuration further includes mappings between the configured TCI states in the shared TCI state configuration information and TCI states in the multiple TCI state indication modes.

Aspect 22: The method of Aspect 21, wherein the mappings include a mapping between the configured TCI states in the shared TCI state configuration information and TCI states for joint downlink and uplink TCI state indication, a mapping between the configured TCI states in the shared TCI state configuration information and TCI states for separate downlink TCI state indication, and a mapping between the configured TCI states in the shared TCI state configuration information and TCI states for separate uplink TCI state indication.

Aspect 23: The method of any of Aspects 20-22, wherein the shared TCI state configuration information includes a set of configured TCI states for the joint downlink and uplink TCI state indication mode, and the TCI configuration further includes a mapping between the configured TCI states for the joint downlink and uplink TCI state indication mode and TCI states for the separate downlink and uplink TCI state indication mode.

Aspect 24: The method of any of Aspects 19-23, wherein the shared TCI state configuration information includes, for each configured TCI state in a set of configured TCI states identified in the shared TCI state configuration information, an indication of one or more quasi co-location (QCL) types for the configured TCI state and an indication of a respective source reference signal for the configured TCI state for each of the one or more QCL types.

Aspect 25: The method of Aspect 24, wherein the shared TCI state configuration information further includes, for each configured TCI state in the set of configured TCI states identified in the shared TCI state configuration information, at least one of bandwidth part or component carrier identifier information associated with the configured TCI state.

Aspect 26: The method of any of Aspects 24-25, wherein the shared TCI state configuration information further includes, for each configured TCI state in a set of configured TCI states identified in the shared TCI state configuration information, an indication of power control parameters and a path loss reference signal associated with the configured TCI state.

Aspect 27: The method of any of Aspects 19-26, wherein the indication is included in at least one of a medium access control (MAC) control element or downlink control information.

Aspect 28: The method of any of Aspects 19-27, wherein the indication indicates an activated TCI state indication mode of the multiple TCI state indication modes.

Aspect 29: The method of any of Aspects 19-28, wherein the indication includes a dynamic indication of a TCI state for a channel and a TCI state indication mode, of the multiple TCI state indication modes, for the TCI state for the channel.

Aspect 30: The method of any of Aspects 19-29, wherein the indication is an indication of a separate uplink TCI state indication mode or a joint downlink and uplink TCI state indication mode, and the indication identifies power control parameters for an uplink transmission using the beam direction associated with the TCI state in the TCI state indication mode.

Aspect 31: The method of Aspect 30, wherein the indication indicates an index associated with a configured set of power control parameters.

Aspect 32: The method of any of Aspects 19-31, wherein the indication indicates at least one of: one or more channels associated with the TCI state in the TCI state indication mode, or one or more reference signals associated with the TCI state in the TCI state indication mode.

Aspect 33: An apparatus for wireless communication at a device, comprising a processor; memory coupled with the processor; and instructions stored in the memory and executable by the processor to cause the apparatus to perform the method of one or more of Aspects 1-18.

Aspect 34: An apparatus for wireless communication at a device, comprising a processor; memory coupled with the processor; and instructions stored in the memory and executable by the processor to cause the apparatus to perform the method of one or more of Aspects 19-32.

Aspect 35: A device for wireless communication, comprising a memory and one or more processors coupled to the memory, the one or more processors configured to perform the method of one or more of Aspects 1-18.

Aspect 36: A device for wireless communication, comprising a memory and one or more processors coupled to the memory, the one or more processors configured to perform the method of one or more of Aspects 19-32.

Aspect 37: An apparatus for wireless communication, comprising at least one means for performing the method of one or more of Aspects 1-18.

Aspect 38: An apparatus for wireless communication, comprising at least one means for performing the method of one or more of Aspects 19-32.

Aspect 39: A non-transitory computer-readable medium storing code for wireless communication, the code comprising instructions executable by a processor to perform the method of one or more of Aspects 1-18.

Aspect 40: A non-transitory computer-readable medium storing code for wireless communication, the code comprising instructions executable by a processor to perform the method of one or more of Aspects 19-32.

Aspect 41: A non-transitory computer-readable medium storing a set of instructions for wireless communication, the set of instructions comprising one or more instructions that, when executed by one or more processors of a device, cause the device to perform the method of one or more of Aspects 1-18.

Aspect 42: A non-transitory computer-readable medium storing a set of instructions for wireless communication, the set of instructions comprising one or more instructions that, when executed by one or more processors of a device, cause the device to perform the method of one or more of Aspects 19-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, from a base station, a transmission configuration indicator (TCI) configuration that includes shared TCI state configuration information for multiple TCI state indication modes;
receive, from the base station, an indication of a TCI state indication mode of the multiple TCI state indication modes; and
communicate with the base station using a beam direction associated with a TCI state in the TCI state indication mode based at least in part on the shared TCI state configuration information.

2. The UE of claim 1, wherein the multiple TCI state indication modes include a joint downlink and uplink TCI state indication mode and a separate downlink and uplink TCI state indication mode.

3. The UE of claim 2, wherein the shared TCI state configuration information includes a set of configured TCI states, and the TCI configuration further includes mappings between the configured TCI states in the shared TCI state configuration information and TCI states in the multiple TCI state indication modes.

4. The UE of claim 3, wherein the mappings include a mapping between the configured TCI states in the shared TCI state configuration information and TCI states for joint downlink and uplink TCI state indication, a mapping between the configured TCI states in the shared TCI state configuration information and TCI states for separate downlink TCI state indication, and a mapping between the configured TCI states in the shared TCI state configuration information and TCI states for separate uplink TCI state indication.

5. The UE of claim 2, wherein the shared TCI state configuration information includes a set of configured TCI states for the joint downlink and uplink TCI state indication mode, and the TCI configuration further includes a mapping between the configured TCI states for the joint downlink and uplink TCI state indication mode and TCI states for the separate downlink and uplink TCI state indication mode.

6. The UE of claim 1, wherein the shared TCI state configuration information includes, for each configured TCI state in a set of configured TCI states identified in the shared TCI state configuration information, an indication of one or more quasi co-location (QCL) types for the configured TCI state and an indication of a respective source reference signal for the configured TCI state for each of the one or more QCL types.

7. The UE of claim 6, wherein the shared TCI state configuration information further includes, for each configured TCI state in the set of configured TCI states identified in the shared TCI state configuration information, at least one of bandwidth part or component carrier identifier information associated with the configured TCI state.

8. The UE of claim 6, wherein the shared TCI state configuration information further includes, for each configured TCI state in a set of configured TCI states identified in the shared TCI state configuration information, an indication of power control parameters and a path loss reference signal associated with the configured TCI state.

9. The UE of claim 8, wherein indication of a TCI state indication mode is an indication of a separate downlink TCI state indication mode, and the one or more processors, to communicate with the base station using a beam direction associated with a TCI state in the TCI state indication mode, are configured to:
derive a TCI state for the separate downlink TCI state indication mode from a configured TCI state in the set of configured TCI states identified in the shared TCI state configuration information; and
receive, from the base station, a downlink communication using a beam direction associated with the TCI state for the separate downlink TCI state indication mode, without applying the power control parameters associated with the configured TCI state from which the TCI state for the separate downlink TCI state indication mode is derived.

10. The UE of claim 1, wherein the indication is included in at least one of a medium access control (MAC) control element or downlink control information.

11. The UE of claim 1, wherein the indication indicates an activated TCI state indication mode of the multiple TCI state indication modes.

12. The UE of claim 1, wherein the indication includes a dynamic indication of a TCI state for a channel and a TCI state indication mode, of the multiple TCI state indication modes, for the TCI state for the channel.

13. The UE of claim 1, wherein the indication is an indication of a separate uplink TCI state indication mode or a joint downlink and uplink TCI state indication mode, and the indication identifies power control parameters for an uplink transmission using the beam direction associated with the TCI state in the TCI state indication mode.

14. The UE of claim 13, wherein the indication indicates an index associated with a configured set of power control parameters.

15. The UE of claim 1, wherein the indication indicates at least one of:
one or more channels associated with the TCI state in the TCI state indication mode, or
one or more reference signals associated with the TCI state in the TCI state indication mode.

16. The UE of claim 1, wherein the shared TCI state configuration information identifies configured TCI states and respective uplink reference signals associated with the configured TCI states, wherein the indication is an indication of a separate downlink TCI state indication mode, and wherein the one or more processors, to communicate with the base station using a beam direction associated with a TCI state in the TCI state indication mode, are configured to:
selectively use the respective uplink reference signal associated with one of the configured TCI states or a downlink reference signal as a source reference signal for determining the beam direction associated with the TCI state in the separate downlink TCI state indication mode based at least in part on a capability of the UE.

17. The UE of claim 16, wherein the one or more processors, to selectively use the respective uplink reference signal associated with one of the configured TCI states or a downlink reference signal as a source reference signal for determining the beam direction associated with the TCI state in the separate downlink TCI state indication mode, are configured to:
use the downlink reference signal as the source reference signal for determining the beam direction associated with the TCI state in the separate downlink TCI state indication mode, wherein the downlink reference signal is a reference signal used to define the respective uplink reference signal associated with the one of the configured TCI states.

18. The UE of claim 16, wherein the one or more processors, to selectively use the respective uplink reference signal associated with one of the configured TCI states or a downlink reference signal as a source reference signal for determining the beam direction associated with the TCI state in the separate downlink TCI state indication mode, are configured to:
use the downlink reference signal as the source reference signal for determining the beam direction associated with the TCI state in the separate downlink TCI state indication mode, wherein the downlink reference signal is identified in an indication received from the base station.

19. A base station for wireless communication, comprising:
a memory; and
one or more processors, coupled to the memory, configured to:
transmit, to a user equipment (UE), a transmission configuration indicator (TCI) configuration that includes shared TCI state configuration information for multiple TCI state indication modes;
transmit, to the UE, an indication of a TCI state indication mode of the multiple TCI state indication modes; and
communicate with the UE using a beam direction associated with a TCI state in the TCI state indication mode based at least in part on the shared TCI state configuration information.

20. The base station of claim 19, wherein the multiple TCI state indication modes include a joint downlink and uplink TCI state indication mode and a separate downlink and uplink TCI state indication mode.

21. The base station of claim 20, wherein the shared TCI state configuration information includes a set of configured TCI states, and the TCI configuration further includes mappings between the configured TCI states in the shared TCI state configuration information and TCI states in the multiple TCI state indication modes.

22. The base station of claim 21, wherein the mappings include a mapping between the configured TCI states in the shared TCI state configuration information and TCI states for joint downlink and uplink TCI state indication, a mapping between the configured TCI states in the shared TCI state configuration information and TCI states for separate downlink TCI state indication, and a mapping between the configured TCI states in the shared TCI state configuration information and TCI states for separate uplink TCI state indication.

23. The base station of claim 20, wherein the shared TCI state configuration information includes a set of configured TCI states for the joint downlink and uplink TCI state indication mode, and the TCI configuration further includes a mapping between the configured TCI states for the joint downlink and uplink TCI state indication mode and TCI states for the separate downlink and uplink TCI state indication mode.

24. The base station of claim 19, wherein the shared TCI state configuration information includes, for each configured TCI state in a set of configured TCI states identified in the shared TCI state configuration information, an indication of one or more quasi co-location (QCL) types for the configured TCI state and an indication of a respective source reference signal for the configured TCI state for each of the one or more QCL types.

25. The base station of claim 19, wherein the indication indicates an activated TCI state indication mode of the multiple TCI state indication modes.

26. The base station of claim 19, wherein the indication includes a dynamic indication of a TCI state for a channel and a TCI state indication mode, of the multiple TCI state indication modes, for the TCI state for the channel.

27. A method of wireless communication performed by a user equipment (UE), comprising:
receiving, from a base station, a transmission configuration indicator (TCI) configuration that includes shared TCI state configuration information for multiple TCI state indication modes;
receiving, from the base station, an indication of a TCI state indication mode of the multiple TCI state indication modes; and
communicating with the base station using a beam direction associated with a TCI state in the TCI state indication mode based at least in part on the shared TCI state configuration information.

28. The method of claim 27, wherein the multiple TCI state indication modes include a joint downlink and uplink TCI state indication mode and a separate downlink and uplink TCI state indication mode, and wherein the shared TCI state configuration information includes a set of configured TCI states, and the TCI configuration further includes mappings between the configured TCI states in the shared TCI state configuration information and TCI states in the multiple TCI state indication modes.

29. The method of claim 27, wherein the shared TCI state configuration information includes, for each configured TCI state in a set of configured TCI states identified in the shared TCI state configuration information, an indication of one or more quasi co-location (QCL) types for the configured TCI state and an indication of a respective source reference signal for the configured TCI state for each of the one or more QCL types.

30. A method of wireless communication performed by a base station, comprising:
transmitting, to a user equipment (UE), a transmission configuration indicator (TCI) configuration that includes shared TCI state configuration information for multiple TCI state indication modes;
transmitting, to the UE, an indication of a TCI state indication mode of the multiple TCI state indication modes; and
communicating with the UE using a beam direction associated with a TCI state in the TCI state indication mode based at least in part on the shared TCI state configuration information.
